(19) United States
(12) Patent Application Publication
(10) Pub. No.: US 2023/0342937 A1
(43) Pub. Date: Oct. 26, 2023

(54) VEHICLE IMAGE ANALYSIS

(71) Applicant: UVeye Ltd., Tel Aviv (IL)

(72) Inventors: Amir HEVER, Tel-Aviv (IL); Ilya BOGOMOLNY, Modiin (IL)

(21) Appl. No.: 18/027,809

(22) PCT Filed: Sep. 19, 2021
(86) PCT No.: PCT/IL2021/051140

§ 371 Date: Mar. 22, 2023

Related U.S. Application Data
(60) Provisional application No. 63/081,971, filed on Sep. 23, 2020.

(51) Int. Cl. G06T 7/10; G06V 20/60

(52) U.S. Cl. CPC G06T 7/10; G06V 20/60; G06V 2201/08; G06T 2207/30204

(57) ABSTRACT

A method for determining a fingerprint of a vehicle, including receiving a vehicle identifier and, from at least one sensor, at least one vehicle appearance each including image data informative of vehicle scan. The said appearance is associated with a unique appearance time tag. Then, segmenting the image data into segments each being informative of components of the vehicle. Then, determining marker instances from the image scan, wherein each marker instance is associated with a marker class and marker features. Then, storing data indicative of the vehicle's fingerprint including the vehicle identifier and its corresponding (i) vehicle appearance and associated appearance time tag, (ii) the so determined marker instances, thereby facilitating verification of the fingerprint of the vehicle in future vehicle scan(s).

### TECHNICAL FIELD

The presently disclosed subject matter relates, in general to the field of vehicle image analysis, and more specifically, to methods and a system for vehicle identity verification.

### BACKGROUND

Vehicle identification is commonly performed in various use cases such as parking lot entry, toll roads, restricted access control, and more. In some cases, the identification process is done using the vehicle license plate number which is obtained either by a human or by an automatic license plate recognition system. In some cases, the obtained license plate number is then compared to a known set of license plates which contain additional information such as billing address for toll roads, entry and exit times for parking lot billing, or vehicles with access to a secured facility.

The main limitation of such a method is that license plates are easily modified, making them a non-reliable method of vehicle identity verification.

The following invention describes a system for vehicle identity verification, by means of a “vehicle fingerprint”, which is based on independent sensing such as image or audio recordings of the vehicle.

There is a need in the art for a fingerprint verification system for vehicles.

### GENERAL DESCRIPTION

In accordance with an aspect of the presently disclosed subject matter, there is provided a method for determining a fingerprint of a vehicle, comprising, by a processor and memory circuitry (PMC):
a) receiving a vehicle identifier;
b) receiving, from at least one sensor, at least one vehicle appearance each including at least one image data indicative of at least partial vehicle scan; the appearance is associated with a unique appearance time tag;
c) segmenting the image data into segment data that includes segments each being informative of a respective at least one-sub-component of the vehicle;
d) determining a plurality of marker instances from the image scan or segment data, wherein each marker instance is associated with a marker class and at least one marker feature;
e) storing in the storage data indicative of the vehicle's fingerprint including the vehicle identifier and at least its corresponding (i) vehicle appearance and associated appearance time tag, (ii) the so determined marker instances, thereby facilitating verification of the fingerprint of the vehicle in future vehicle scan(s).

In accordance with an embodiment of the presently disclosed subject matter, there is provided a method further comprising: determining at least one marker feature instance for each one of the marker instances and for at least one of the marker classes of the marker instance, determining at least one marker feature instance that is location dependent; and, for each marker instance, storing the so determined marker feature instances including the component dependent marker features.

In accordance with an embodiment of the presently disclosed subject matter, there is further provided a method, including with respect to the vehicle, repeating (b) to (e) for at least one more vehicle appearance having a corresponding unique time tag, and for at least one other vehicle.

In accordance with an embodiment of the presently disclosed subject matter, there is yet further provided a method wherein the marker class is selected from the group that includes: scratches, dents, handwriting, color, rust mark, cross-type screws, and printed text.

In accordance with an embodiment of the presently disclosed subject matter, there is yet further provided a method wherein at least one of the sensors is an IR sensor and wherein at least one of the vehicle scans falls in the IR wavelength.

In accordance with an embodiment of the presently disclosed subject matter, there is yet further provided a method, wherein at least one of the sensors is an audio sensor and further comprising obtaining at least one audio scan of the vehicle and determining at least one audio marker class from the scan informative of sound of at least one module associated with the vehicle.

In accordance with an embodiment of the presently disclosed subject matter, there is yet further provided a method, wherein at least one of the sensors is an electromagnetic sensor and further comprising obtaining at least one electromagnetic scan of the vehicle and determining at least one electromagnetic marker class from the scan informative of a mark concealed underneath a non-metal surface of the vehicle.

In accordance with an aspect of the presently disclosed subject matter, there is yet further provided a method for verifying a fingerprint of a vehicle, comprising by a processor and associated memory storage:
a) receiving a vehicle identifier;
b) receiving from at least one sensor at least one new vehicle appearance, each including at least one image data indicative of at least a partial vehicle scan; the appearance is associated with a unique appearance time tag;
c) segmenting the image data into segment data that includes segments each being informative of a respective at least one-sub-component of the vehicle;
d) determining a plurality of new marker instances from the image scan or segment data, wherein each new marker instance is associated with a marker class and at least one marker feature;
e) extracting from the storage previously stored at least one vehicle appearance that is associated with the vehicle identifier and at least one of its corresponding marker instances; and
f) comparing at least one new marker instance of the new appearance with a corresponding marker instance of at least one previously stored appearance of the same vehicle identifier, and validating the vehicle fingerprint if a matching criterion is met.

In accordance with an embodiment of the presently disclosed subject matter, there is yet further provided a method, wherein (d) further includes determining at least one new marker feature instance for each one of the new marker instances and for at least one of the marker classes of the new instances, determining at least one marker feature instance that is location dependent, and wherein the extracting step includes: for each marker instance, extracting determined marker features including location dependent marker features, and wherein the comparing includes comparing each new marker instance with at least one marker instance of at least one previously stored appearance of the vehicle for determining respective similarity scores, and in case at least one of said similarity scored exceeds a threshold validating the new marker instance, determining if the matching criterion is met based on at least the validated marker instances and the corresponding stored marker instances.

In accordance with an embodiment of the presently disclosed subject matter, there is yet further provided a method, further comprising for at least one validated marker instance of the newly acquired appearance, determining, utilizing a narrowing criterion, at least one candidate reference marker instance out of the larger number of stored reference marker instances of at least one vehicle appearance, and determining whether the matching criterion is met based on at least the validated marker instances and the corresponding stored candidate reference marker instances.

In accordance with an embodiment of the presently disclosed subject matter, there is yet further provided a method, wherein the matching criterion is met if the number of validated marker instances out of the corresponding stored marker instances exceeds a given threshold.

In accordance with an embodiment of the presently disclosed subject matter, there is yet further provided a method, wherein at least some of the features are component dependent, and wherein the comparison is segment dependent thereby reducing the false alarms and computational complexity of the comparison.

In accordance with an embodiment of the presently disclosed subject matter, there is yet further provided a method, wherein in case that a matching criterion is met with respect to the validated vehicle, the new marker instances of the validated vehicle that did not meet the similarity score are stored together with their associated feature instances for improving future vehicle verification.

In accordance with an embodiment of the presently disclosed subject matter, there is yet further provided a method, wherein the marker class is selected from the group that includes: scratches, dents, handwriting, color, rust mark, cross-type screws, and printed text.

In accordance with an embodiment of the presently disclosed subject matter, there is yet further provided a method, wherein at least one of the sensors is an IR sensor, and wherein at least one of the vehicle scans falls in the IR wavelength.

In accordance with an embodiment of the presently disclosed subject matter, there is yet further provided a method, wherein at least one of the sensors is an audio sensor and further comprising obtaining at least one audio scan of the vehicle and determining at least one audio marker class from the scan informative of sound of at least one module associated with said vehicle, and wherein the extracting and comparing apply also to said audio marker classes.

In accordance with an embodiment of the presently disclosed subject matter, there is yet further provided a method, wherein at least one of said sensors is an electromagnetic sensor and further comprising obtaining at least one electromagnetic scan of the vehicle and determining at least one electromagnetic marker class from the scan informative of a mark concealed underneath a non-metal surface of the vehicle, and wherein the extracting and comparing apply also to the electromagnetic marker classes.

In accordance with an aspect of the presently disclosed subject matter, there is yet further provided a computerized system for determining a fingerprint of a vehicle, the system comprising a processor and memory circuitry (PMC) configured to perform:
receive a vehicle identifier;
receive, from at least one sensor, at least one vehicle appearance each including at least one image data indicative of at least partial vehicle scan; the appearance is associated with a unique appearance time tag;
segment the image data into segment data that includes segments, each being informative of a respective at least one-sub-component of the vehicle;
determine a plurality of marker instances from the image scan or segment data, wherein each marker instance is associated with a marker class and at least one marker feature;
store, in the storage, data indicative of the vehicle's fingerprint, including the vehicle identifier and at least its corresponding (i) vehicle appearance and associated appearance time tag, (ii) the so determined marker instances, thereby facilitating verification of the fingerprint of the vehicle in future vehicle scan(s).

In accordance with an embodiment of the presently disclosed subject matter, there is yet further provided a system for determining a fingerprint of a vehicle which further includes any of the embodiments outlined above with reference to the method.

In accordance with an aspect of the presently disclosed subject matter, there is yet further provided a computerized system for verifying a fingerprint of a vehicle, the system comprising a processor and memory circuitry (PMC) configured to perform:
receive a vehicle identifier;
receive from at least one sensor at least one new vehicle appearance each including at least one image data indicative of at least partial vehicle scan; the appearance is associated with a unique appearance time tag;
segment the image data into segment data that includes segments each being informative of a respective at least one-sub-component of the vehicle;
determine a plurality of new marker instances from the image scan or segment data, wherein each new marker instance is associated with a marker class and at least one marker feature;
extract from the storage previously stored at least one vehicle appearance that is associated with the vehicle identifier and at least one of its corresponding marker instances; and
compare at least one new marker instance of the new appearance with the corresponding marker instance of at least one previously stored appearance of the same vehicle identifier, and validating the vehicle fingerprint if a matching criterion is met.

In accordance with an embodiment of the presently disclosed subject matter, there is yet further provided a system for verifying a fingerprint of a vehicle which further includes any of the embodiments outlined above with reference to the method.

In accordance with an embodiment of the presently disclosed subject matter, there is yet further provided a non-transitory computer readable medium comprising instructions that, when executed by a computer, cause the computer to perform the method steps as outlined above.

A non-transitory computer readable medium comprising instructions that, when executed by a computer, cause the computer to perform method steps as outlined above.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1—schematically illustrates a block diagram of a computerized system capable of uniquely identifying vehicles in accordance with certain embodiments of the presently disclosed subject matter.

FIG. 2—Illustrates a generalized flowchart of new vehicle sign up process.

FIG. 3—Illustrates an example of an input image and corresponding component segments in accordance with certain embodiments of the presently disclosed subject matter.

FIG. 4—Illustrates a generalized processing flow for a single marker.

FIG. 5—Illustrates an example database structure for the vehicle identity verification process. Specifically, FIG. 5a is the general database, and FIG. 5b specifies which information is stored for each marker and its appearance.

FIG. 6—Illustrates a generalized flowchart of vehicle identity verification in accordance with certain embodiments of the presently disclosed subject matter.

FIG. 7—Illustrates a generalized flowchart of comparing new and existing markers in accordance with certain embodiments of the presently disclosed subject matter.

FIG. 8a—Illustrates a generalized flowchart of computing a vehicle marker of marker class “color”, in accordance with certain embodiments of the presently disclosed subject matter.

FIG. 8b—Illustrates a generalized flowchart of computing a vehicle marker of the marker class “cross type screw”, in accordance with certain embodiments of the presently disclosed subject matter, and

FIG. 9—Illustrates a visual example of additional marker classes, in accordance with certain embodiments of the presently disclosed subject matter.

### DETAIL DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter. Unless specifically stated otherwise, as apparent from the following discussions, it is appreciated that throughout the specification discussions utilizing terms such as “receiving”, “segmenting”, “determining”, “calculating”, “meeting”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the computerized system verifying the fingerprint of a vehicle, the computerized system of determining and logging the fingerprint of a vehicle, and the processing and memory circuitry (PMC) of these systems as disclosed in the present application.

The operations in accordance with the teachings herein can be performed by a computer specially constructed for the desired purposes or by a general purpose computer specially configured for the desired purpose by a computer program stored in a non-transitory computer readable storage medium.

The terms “non-transitory memory”, “non-transitory storage medium” and “non-transitory computer readable storage medium” used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

As used herein, the phrase “for example,” “such as”, “for instance” and variants thereof describe non-limiting embodiments of the presently disclosed subject matter. Reference in the specification to “one case”, “some cases”, “other cases” or variants thereof, means that a particular feature, structure, or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately, or in any suitable sub-combination. In the following detailed description, numerous specific details are set forth in order to provide a thorough understanding of the methods and apparatus.

In embodiments of the presently disclosed subject matter one or more stages illustrated in the figures may be executed in a different order and/or one or more groups of stages may be executed simultaneously, and vice versa.

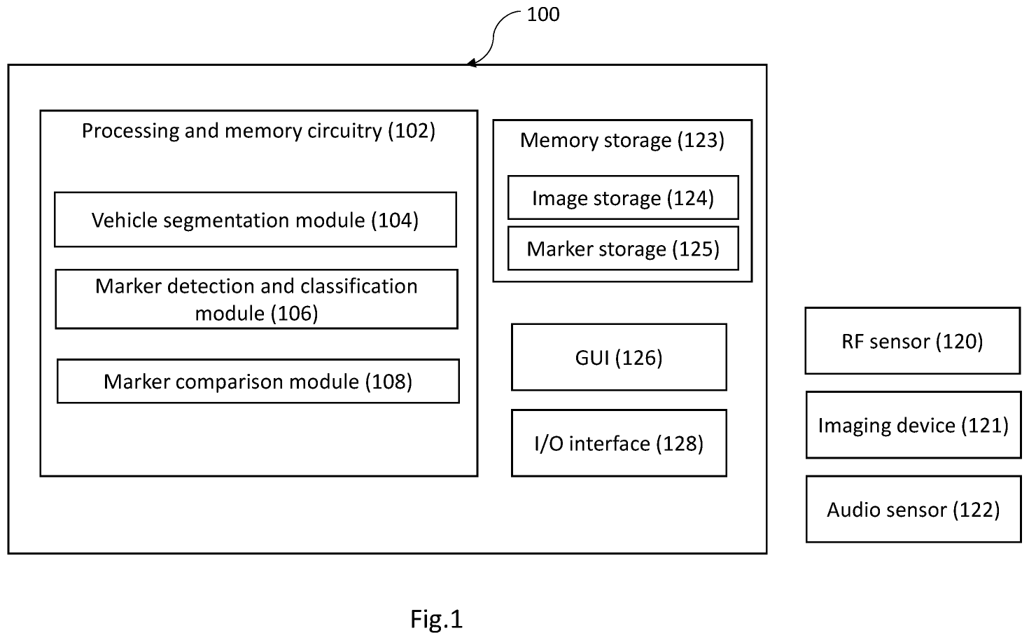

The system 100 illustrated in FIG. 1 is a computer-based vehicle identity verification system. System 100 can be configured to obtain via hardware I/O interface 126, a vehicle scan acquired by one or more sensors 121, 122, which capture information of at least part of a vehicle (vehicle image and/or vehicle audio recording). A sensor may be for example an) image acquisition device such as a camera or, for example, a sound acquisition device such as a microphone. Other non-limiting examples are an IR sensor (capable, for instance, of acquiring the heat signature of various parts of the vehicle, or images under low illumination conditions), or a Radar/Lidar transceiver sensor capable of transmitting electromagnetic signals that will impinge upon the vehicle and which are reflected therefrom. The so reflected signal may be received by the radar and may be representative of the (“electromagnetic signature”) of an object such as a dent or crack concealed below the surface of the vehicle.

It is noted the term vehicle used herein should be expansively construed to cover any kind of motor vehicle, including but not limited to cars, buses, motorcycles, trucks, trains, and airplanes, etc. The present disclosure is not limited by the type and usage of a specific vehicle, nor by the state of the vehicle being either static or in motion.

The imaging device 121 can be any kind of image acquisition device(s) or general-purpose device(s) equipped with image acquisition functionalities that can be used to capture vehicle images at a certain resolution and frequency, such as, e.g. a digital camera with image and/or video recording functionalities.

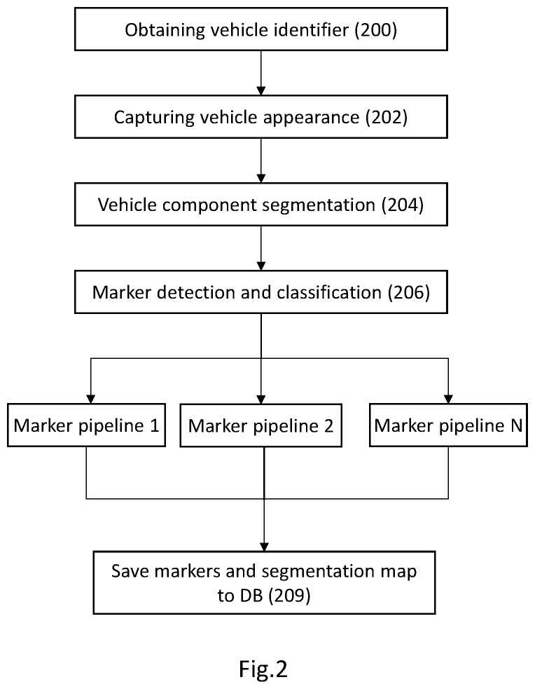

As illustrated, system 100 can comprise a processing and memory circuitry (PMC) 102 operatively connected to the I/O interface 128 and a memory storage 123. PMC 102 is configured to provide all processing necessary for operating system 100 which is further detailed with reference to FIGS. 2, 4-8. PMC 102 comprises a processor (not shown separately) and a memory. The processor PMC 102 can be configured to execute several functional modules in accordance with computer-readable instructions implemented on a computer readable non-transitory computer-readable memory comprised in the PMC. Such functional modules are referred to hereinafter as comprised in the PMC.

In certain embodiments, functional modules comprised in the PMC 102 can comprise a vehicle segmentation module 104, a marker detection and classification module 106, and a marker comparison module 108. The functional modules in the PMC are operatively connected with each other.

In accordance with the presently disclosed subject matter, the term marker class should be extensively construed to indicate a unique marker type associated with a marker instance. For example, X marker instances are determined from a given vehicle appearance (as will be explained in greater detail below), all having the same marker class “scratch”. Intuitively, by this example, there are X scratch markers (instances). By way of another example, Z marker instances may be determined from a given appearance, of which X instances are classified as “scratch” (marker class=“scratch”) and Y are of “dents” (marker class=“dent”), where X+Y=Z. A marker class may be, for example, visual, audio, IP, electromagnetic etc. The description herein exemplifies numerous examples of marker classes (e.g. visible markers, scratches, dents, cracks, written text, whether on the surface of the vehicle or concealed underneath, etc.). Each marker has marker class features that characterize the marker, typically but not necessarily according to the marker class. Some features (e.g. component coordinates) may be common to different marker classes. The term marker (or marker class feature) instance refers to the specific instance of a marker—say a given scratch that was determined from a given appearance. The term marker class feature may refer to one or more features of a marker, and the term marker feature instance refers to a specific value of the feature. There may be different features for different marker classes. Thus, for example, a given marker may be classified as belonging to marker class “handwriting”, and it may have the following features “component” (informative of which component on the vehicle it appears) and “coordinates” (informative of the coordinates on the component on which the handwriting marker appears). The feature instances are the specific value of the feature (say “wheel” and coordinates x,y) of a given marker instance (i.e. a specific “handwriting” instance), all as will be exemplified in greater detail below.

The marker detection and classification module can be configured to detect and classify vehicle identity markers (VIM) instances (sometimes referred in short also as “markers”), which are visible appearing on/in the vehicles throughout the vehicles' lifetime (and which are extracted from the vehicle scan). Other classes of markers may be obtained from sound or electromagnetic scans that are derived from respective hearable and/or electromagnetic sensors (such as, say Radar/Lidar), which may be extracted from a sound scan or electromagnetic scan respectively. The former may be used to identify, say, sounds that originate from a given vehicle's mechanism (such as the sound of a motor assembly) and the latter may serve e.g. for revealing, from the electromagnetic scan, concealed damages such as concealed (i.e. below the surface) cracks or dents.

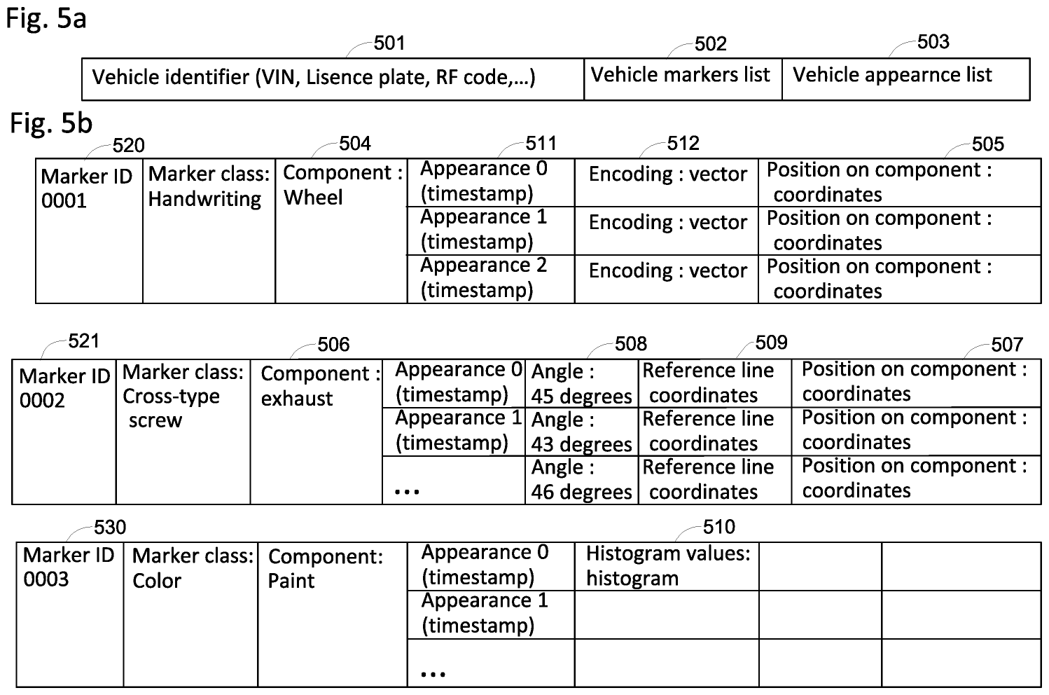

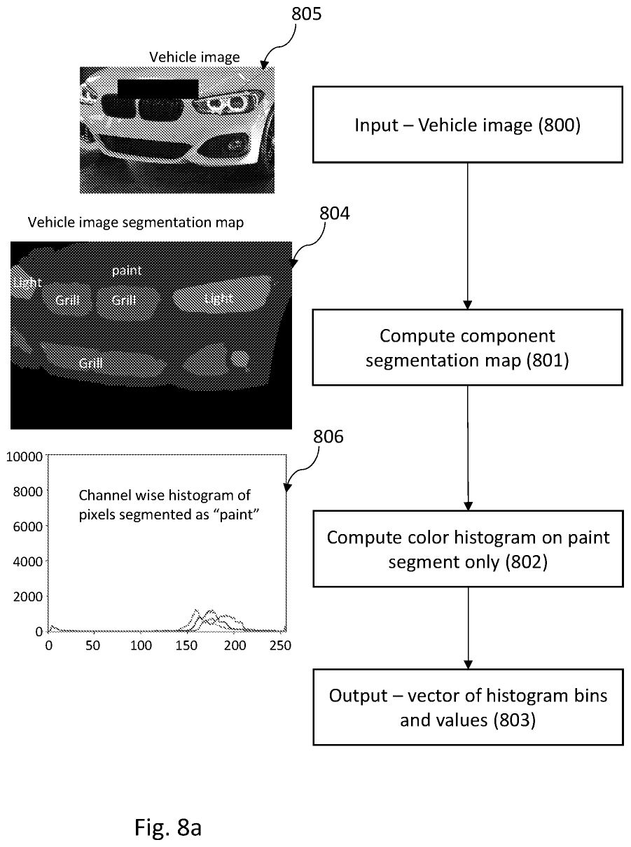

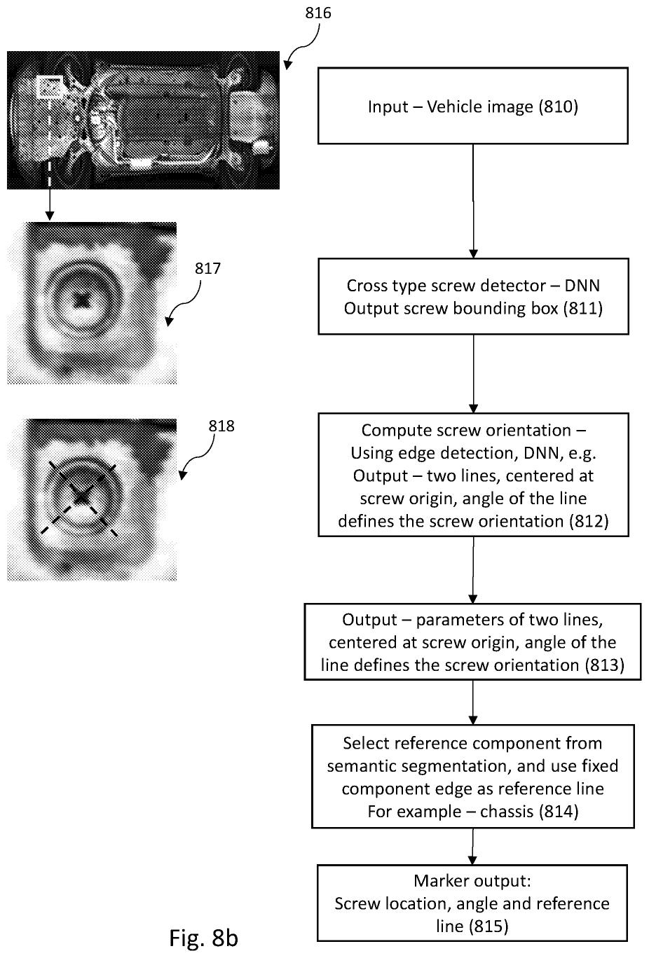

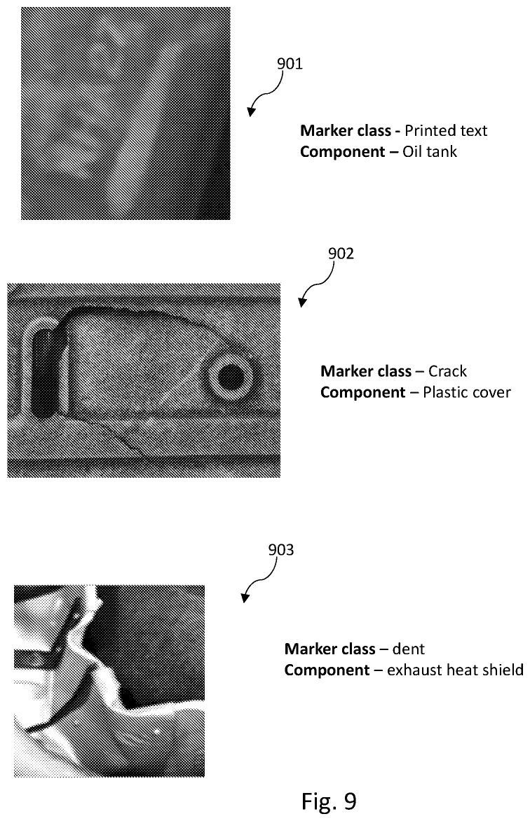

The electromagnetic scan may be obtained by transmitting from a LIDAR electromagnetic signal and receiving the reflection thereof from the vehicle. At least some of these marker classes are caused uniquely by the usage of the vehicle, and are not likely to appear on/in other vehicles. Examples of such VIM classes can be scratches, dents, handwriting, color, cross-type screws etc., The classes of VIM and their methods of computation are described in detail in FIGS. 8-9. The computed VIM classes and their associated feature instances (as will be explained in greater detail below) can be stored in memory module 123, which is further described with FIG. 5. Some of the VIMs are location dependent, location meaning the exact position on the vehicle as captured by the sensor. An example of a location dependent VIM is a scratch. There can be many scratches with similar appearance on the vehicle. In accordance with certain embodiments, other marker classes may be scratches, rust marks, screw orientations, handwriting, paint marks, serial numbers, stickers, dents, or any other mechanical deformation, and the position of electrical wires. These are only non-limiting examples of marker classes.

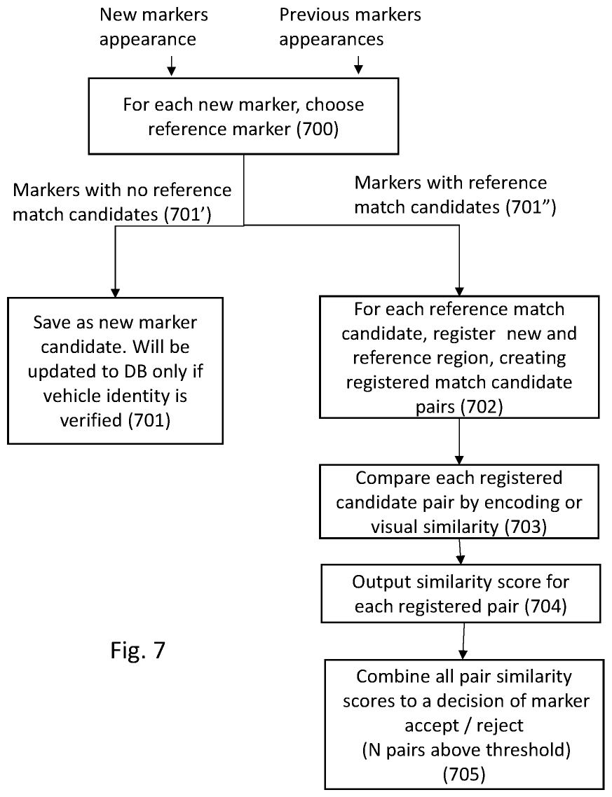

Marker comparison module 108 can be configured to retrieve appearances of VIM (marker instances) on different vehicle appearances from memory storage 123 and compare the VIM appearances, providing a similarity score which is indicative of the VIM instance being the same or not to the one or more instances stored in the database. This is further described with reference to FIG. 7.

It is also noted that the system illustrated in FIG. 1 can be implemented in a distributed computing environment, in which the aforementioned functional modules shown in FIG. 1 can be distributed over several local and/or remote devices, and can be linked through a communication network.

Those versed in the art will readily appreciate that the teachings of the presently disclosed subject matter are not bound by the system illustrated in FIG. 1; equivalent and/or modified functionality can be consolidated or divided in another manner and can be implemented in any appropriate combination of software with firmware and hardware. The system in FIG. 1, or at least certain components thereof, can be a standalone network entity, or integrated, fully or partly, with other network entities. Those skilled in the art will also readily appreciate that the data repositories or storage unit therein can be shared with other systems or be provided by other systems, including third party equipment.

Vehicle identity verification starts from vehicle sign up which is described in FIG. 2, which is the process of adding a new vehicle instance (appearance) to the system. In accordance with certain embodiments, the sequence of operations described with reference to FIG. 2 (and/or) specific sub stages described with reference to other FIGS. illustrate non-limiting examples of determining a fingerprint of a vehicle for various purposes, including verifying the identity thereof.

Thus, first, a vehicle identifier (e.g. string) is obtained (200). Vehicle identifier can be any unique entry to specify the vehicle. By way of example, vehicle identifier can be a vehicle license plate (LP) or vehicle identification number (VIN) (say, a unique code provided by the manufacturer). The identifier can be obtained automatically using a dedicated computer system, or in any other way, including manual entry by a human operator.

The next step is capturing vehicle appearance 202, which includes scanning the vehicle or parts of it using sensors 120-122. The information obtained 202 can include vehicle image, vehicle sound and more, RF signature, WIFI MAC address and more.

The information obtained by 202 is stored in 123, together with a vehicle identifier.

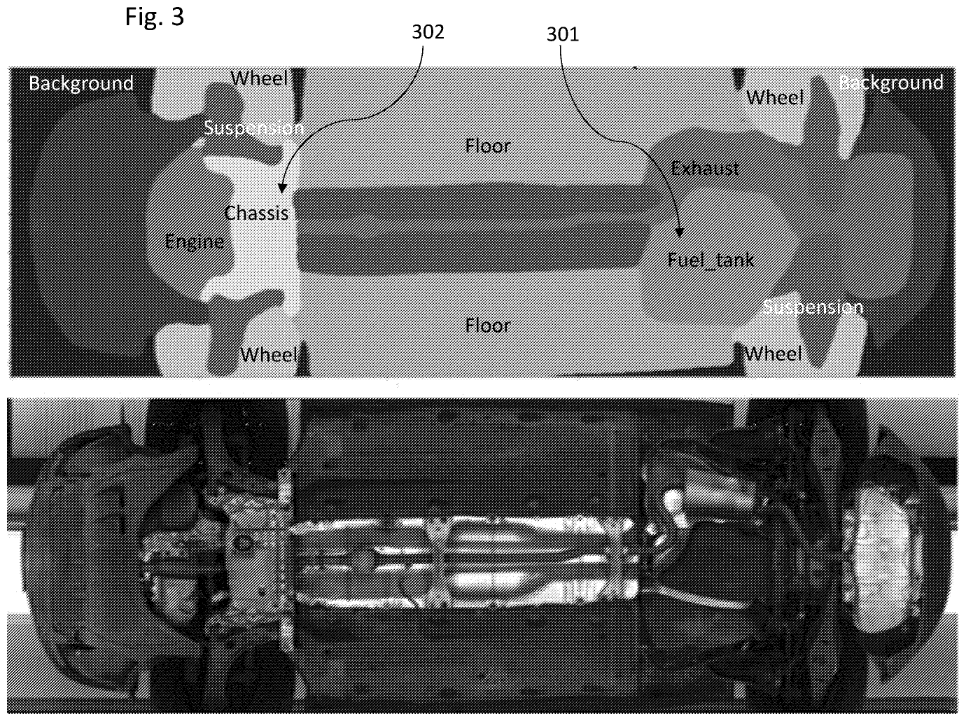

Upon obtaining the vehicle appearance, vehicle images can be provided as input to vehicle component segmentation module 204 (Module 104 of the PMC), which can be in the same segmentation module described e.g. in Col. 9 line 35 to col 11 line 10 and with reference to FIGS. 1, 2 and 4 of U.S. patent Ser. No. 10/650,530, whose contents are incorporated by reference, and which may be part of the system of the presently disclosed subject matter. The output component segmentation module may be a component map corresponding to the input vehicle image as illustrated in FIG. 3. It will be elaborated further, how combining the component map will contribute to improving the system's accuracy and reducing computational time.

Note that each segment may be composed of at least a sub component, e.g. complete distinct component, partial component (e.g. sub-components) or a plurality of complete or partial components etc., depending upon the particular application. A component may be a separate physical component (exhaust, fuel tank, drive shaft, oil filter, etc.) As shown, by way of example, FIG. 3 illustrates a bottom view of the fuel tank 301, a partial bottom view of the chassis 302, etc. all depending upon the particular application. For convenience of explanation, the description herein assumes that in the segmentation map each segment represents a component. The invention is, of course, not bound by this example, and accordingly it applies to the other options of segments (e.g. partial components or a few components) etc., mutatis mutandis.

Further, the captured vehicle image can be provided as input to the marker detection and classification module 206 (Module 106 of the PMC) which detects a predefined VIM, and outputs the locations of the detected VIM classes (the terms VIM and marker are used interchangeably). By way of example, a marker instance (say, a defect) of a type of scratch can be detected on a specific image pixel or pixels. Some indication of the pixels may be provided (coordinates of bounding box, pixels list, object center, etc.). Further, the marker detection can be combined with the output of 204, to provide not only the pixel location on the image, but also the mechanical component (in cases where the segment map includes components). The marker instance is detected, e.g., by overlaying the image coordinates of the detected marker with the coordinates of the segment (as obtained in the segmentation map), or intrusively if the image falls within the segment. Further, the marker coordinates can be provided as global image coordinates or relative to the corresponding component as obtained using 204 outputs. The specified data e.g. the pertinent component, coordinates etc. of the detected marker are examples of the marker's feature instance. The latter may be stored for the following markers comparison computational stages, all as will be described in greater detail below.

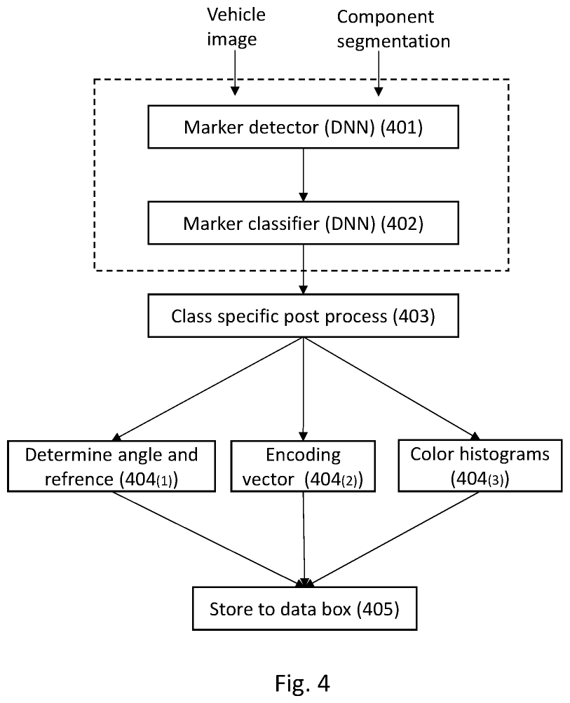

By way of example, the detection and/or classification can be performed by a generally known per se Deep Neural Network DNN (see also 401 in FIG. 4) that may form part of a system according to the presently disclosed subject matter and described e.g. in Col 10. Line 9 to U.S. Ser. No. 10/650,53011 line 10 of US patent U.S. Ser. No. 10/650,530 whose contents are incorporated herein by reference. The invention is not bound by utilization of ML in general, and DNN in particular, which is provided by way of example only.

In some embodiments, the DNN can be trained using a training dataset of pre-annotated VIM. The training images and the annotated VIM are provided as input to the detection and classification DNN for training. The training process is designated to optimize the model in such way that it can correctly predict VIM position on the image and VIM class. In some cases, different training datasets need to be provided so as to train the model to be able to detect marker instances on different vehicle types or different vehicle components in runtime. Intuitively, the markers for vehicles may be conceived like human fingerprints, where all humans have “fingerprints”, but when computing the exact fingerprint features, they will be different for each individual. In the case of vehicles, and considering, for example, the marker class “scratch”, most vehicles have scratches, but they differ from vehicle to vehicle (e.g. in their location, shape, size etc.—the latter examples may represent the marker features of the marker of class “scratch”), and therefore their respective marker feature instances may uniquely identify (possibly with other marker instances of the same or different classes) the vehicle. Thus, for example a “scratch detector” can be trained to identify the scratches that may serve for uniquely identifying vehicles, as explained above.

Reverting to FIG. 4, Class Specific post process module (403) may serve for background removal, axes alignment histogram equalization and so forth, all as known per se.

In some embodiments, following the detection and classification step, some of the markers go to a dedicated processing pipeline predefined for the marker class as obtained from the classification step. The class specific pipelines contain the instruction on which class specific features instances should be computed for the given marker class. For instance, and as shown in FIG. 4, pipeline 404(1) is configured to calculate “angle” and “line reference” feature instances (applicable for the cross-type screw marker class). Pipeline 404(2) is configured to calculate an encoded vector feature (that may be used for a later comparison between a new marker feature instance and previously stored marker feature instances, all as described below), and pipeline 404(3) is configured to calculate the color histogram feature (applicable for the color marker class). Some of the features can be common to different pipelines, and some can be used uniquely as a specific pipeline. It is noted that this is an example of an implementation, and by another example the features to be computed by the pipeline could be stored in an additional database table. Note also that the invention is not bound by utilizing pipeline calculations for determining features, and accordingly other forms of feature calculations may be utilized. The invention is likewise not bound by the specified pipelines.

Following is an example detailed description of the some of the pipelines (each designated to handle a unique marker class or classes):

### Color Marker Class (FIG. 8a)

Given the input vehicle image 800 obtained by 202 and the component segmentation map 801 obtained by 204 (example of such a map is given by 804), a representation of the vehicle color is computed for different vehicle components. By way of example, color can be computed as channel-wise histogram values (wherein a histogram being, by this example, a feature of a marker o “color” marker class) of the entire image, or only pixels of a specific segment such as “paint”, as illustrated in 804. By way of another example, color can be computed as a representation vector (i.e. marker class being a vector) obtained by a DNN trained to encode colors.

Data informative of the color marker class and its associated feature instances may be stored in the memory system 123 and is further exemplified in FIG. 5B below. Exemplary color class features for the marker class color may be the related component, the histogram etc., all as illustrated with reference to FIG. 5. The invention is not bound by the specified color marker class features which are provided for illustrative purposes only.

### Cross-Type Screw Marker Class FIG. 8b

Cross types screws (known also as “Phillips” screws)—are useful markers since they can be used to differentiate (e.g. by the orientation of the screw) the angle of lines in 818 between two completely new vehicles just out of the manufacturing line (meaning there are not yet any other significant markers on the vehicles).

Screw coordinates (an exemplary feature) may be obtained by the marker detection module 206. The input image and detected screw marker are illustrated in 816 and 817 respectively. After a screw has been detected by 811 (206), in some embodiments the slots on the top of the screw are identified (812) and the direction of the slots is referred to as the angle of the screw and are shown in 818 as dashed lines. Intuitively, different angles are likely (possibly with other marker classes' instances) to characterize different cars. By way of example, the slots can be identified using an edge detection algorithm around the center of the detected screw, and a standard algorithm such as RANSAC can be used to estimate the slots line equation. By the latter example, the “angle” is referred to as a marker feature (for the marker class Cross-type screw).

A reference line (e.g. being another feature) on the vehicle image can be selected (814) to provide a reference for the angle computation. Since different vehicle appearances can occur in different angles, using a semantic component as a reference line allows normalizing the screw angle with respect to the overall vehicle orientation, so that the angles can be meaningfully compared between different appearances. By way of example, a reference line can be selected as an edge of a semantic component that is known to be fixed to the vehicle (e.g. chassis). Such an example of a reference line is shown in 818 as a dashed line. Data informative of the Cross-type screw marker class and its associated features (instances) may be stored in the memory system 123 and is further exemplified in FIG. 5B below. Exemplary Cross-type screw class features for the Cross-type screw marker class (discussed above) may be the related component, the screw angle, reference line, screw position in the component etc. The invention is neither bound by the specified Cross-type screw marker class (say “Phillips” screw), nor by the specified marker class features, which are provided for illustrative purposes only.

FIG. 9 illustrates additional examples of marker classes which may appear on the vehicle as a result of usage, and will be unique to each specific vehicle. This makes all defects good identity markers, such as printed (or handwritten) text, cracks, dents, scratches rust, etc. (all of which may be obtained by the marker detection module 206). Their corresponding features are also calculated, such as the image coordinates it was detected on, corresponding component in which the marker resides (the former may be obtained from the component segmentation map), and the relative coordinates of the component. Other feature data may be extracted and stored in addition to or instead of those specified above, depending upon the particular marker class and application.

FIG. 9 illustrates, schematically, non-limiting examples of VIM classes such as printed text marker class on an Oil Tank component (901), a crack marker class on a Plastic Cover component (902), and a dent marker class on an Exhaust Shield component (903). In some embodiments, an encoding vector feature may be computed for the detected marker to enable future comparison to other marker instances (obtained from future scans). By way of example, such an encoding vector can be obtained by a deep neural network (DNN) as further described in detail with reference to FIG. 7 below. All obtained feature instances may be stored in a database (FIG. 5) for future use, all as will be described in detail below.

Note that the specified marker classes are provided by way of example only, and other visual and non-visual (say sound/electromagnetic) marker classes may be utilized in addition to or instead of one or more of the foregoing examples. Reverting now to FIG. 2, following the completion of computational pipelines for each marker class (for determining the corresponding features), the information (i.e. the instances) may be stored to the database (209) as described in FIG. 5.

Looking at FIG. 5a, and at the time of new vehicle sign up, the database will contain the vehicle identifier (200 and 501), the data of the vehicle captured (202) and a list of the marker instances and their feature instances (502) as computed by 206 and possibly utilizing the marker class pipelines (described in detail below). As also shown in FIG. 5A., the database stores data information of the vehicle's appearance list (503) where each vehicle appearance represents a scan of the vehicle in different conditions, say difference in time (say, a scan of the license plate number 12345 yesterday and then today), different direction (say, acquiring the license place from a different LOS), different image acquiring conditions (say, different quality of license plate acquisition), and so forth. Each appearance may represent a different scan. Obviously the same marker instance (say the same scratch) may appear in different appearances (i.e. at different vehicle scans acquired at respective different time tags). FIG. 5b demonstrates an example of a database structure for a marker list (the markers, their classes, and their respective features and feature instances). Each marker instance has a unique ID that can be automatically assigned by the system. At least some of the markers also store the features component and coordinates on which it was located e.g., as inferred from 204 in combination with 206, the class of the marker obtained from 206 (cross-type screw, dent, scratch, handwriting, rust, crack, etc.). Additional feature instances are stored for each marker class. As shown, by way of example only, for the marker class Handwriting (for Marker instance having ID 0001)—520, the following features are calculated and stored: the component 504 on which this particular marker instance appears (e.g. wheel) and the position of the marker on the component 505, where for each appearance (511) (for marker ID 0001 there are three appearances designated 0, 1 and 2, each with its respected time stamp indicative of the time at which the corresponding vehicle scan was acquired) the relevant feature instances are stored. The encoding vector feature 512 may be a vector representation of the marker (i.e. of the handwriting marker instance) and may serve for future comparison between a new “handwriting” marker instance and already stored marker “handwriting” instances, e.g. by comparing the “distance” between the newly acquired vector and already stored, and comparing the comprising result to a threshold, in order to the determine if the vectors are sufficiently close, which may be informative of the fact that the newly acquired handwriting marker instance, and the already stored handwriting marker instance (in one or more previous appearances), are sufficiently similar, all as is explained herein.

Further, for another maker instance, say of cross-type screw marker class (Marker ID 0002) 521, the following feature instances are calculated and stored: the component 506 on which the marker appears and the position of the marker on the component 507, the angle of the screw 508 and the reference line coordinated 509. The angle, reference line and the position may be stored for each distinct scan (appearance).

Still further, for another marker instance of say color marker class (Marker ID 0003) 530, the following feature instances are calculated and stored: the component (e.g. paint) 511 and the color histogram values 510 (stored for each of the appearances).

The features' instances may be calculated by the class-specific computational pipeline, possibly commonly shared by few classes. For example, the same pipeline may extract the component name and the position of the marker on the component for both the “Handwriting” marker class and the “cross type screw” class. Note that there could be an additional database table specifying which features will be stored for each marker class.

Note that the invention is not bound by the specific data structure as illustrated by way of example only in FIGS. 5A and 5B. The invention is likewise neither bound by the specified list of marker classes, nor by their respective features, all provided for illustrative purposes only.

Once stage 209 is complete, the vehicle instance may be registered in the system 100, and for any following scans the system can use at least the sign-up information for vehicle identity verification.

Note that the invention is not bound by the specific sequence of FIG. 2, and accordingly additional stages may be added one or more may be modified, and/or deleted, all depending upon the particular application.

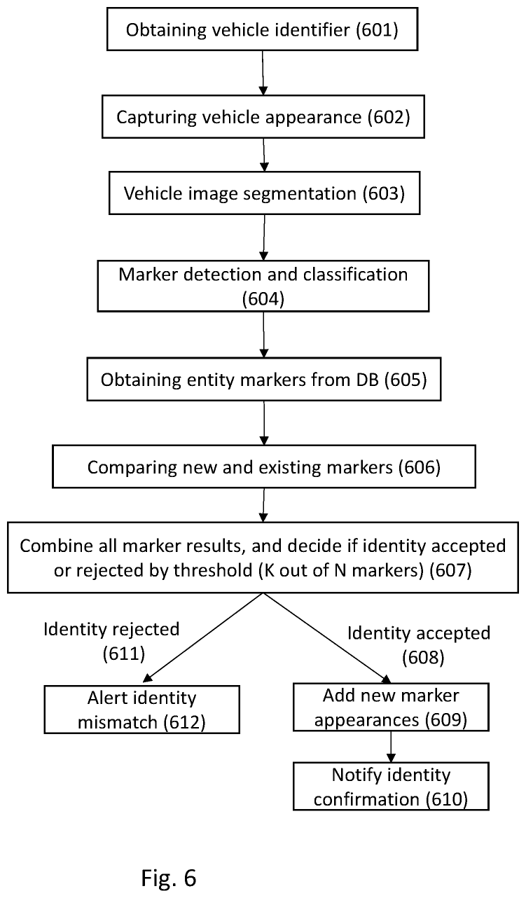

Referring to FIG. 6, further described is the flow of vehicle identity verification for a returning vehicle based on data stored in the database (as described, e.g. with reference to FIG. 5) with respect to the same vehicle. Intuitively, there are N scans of the specific vehicle instance in the system, and the vehicle is scanned by the system for the N+1 time. The N+1 scan is referred to as the new scan, and the system is capable of validating the identity of the vehicle if a matching criterion is met, for instance in accordance with certain embodiments by “comparing” (as will be explained in detail below) marker instances of the N+1^{th}scan to marker instances of the previously stored N scans of to obtain similarity scores. In case a new marker instance as a similarity score exceeds a given threshold, it represents a verified new marker instance. The comparison may refer also to corresponding marker class feature (instances). In case the comparison indicates “sufficient” matching between new marker instances and previously stored marker instances, the identity of the vehicle is validated, or otherwise it is rejected.

Turning specifically to FIG. 6, in accordance with certain embodiments, steps 601-604 are identical to steps 200-206, including obtaining vehicle identifier (601) capturing vehicle appearance (602), image segmentation (603), and marker detection and classification (604). The markers obtained by step 604 of the new scan, are further referred as the new marker instances, and all the marker instances registered for the vehicle instance prior to the new scan are reference marker classes instances. By this embodiment, the new markers may be processed in N marker pipelines for determining the marker feature instances (similar to what is described with reference to FIG. 2 and stage 404 in FIG. 4) and may be saved in the database. (e.g. the one described with reference to FIG. 5), all in a manner described in detail above with reference to FIG. 2.

In step 605, reference marker instances are retrieved from the database for the purpose of comparison to the new markers. In step 606 the new marker instances are compared to reference marker instances (typically broken down by marker feature instances), and, based on the comparison result, similarity scores are obtained, and a decision is made whether a matching criterion is met to validate (namely identify) the vehicle or not (607). In case of validation (608), the new vehicle appearances and their associated new marker feature instances (609) are added to the database (as described in FIG. 5) to obtain more updated data of the vehicle, therefore improving the prospects of identifying, at a higher level of certainty, this particular vehicle in a future vehicle inspection, and appropriate notification is issued (610). Note that in certain embodiments, in case of doubt, a manual inspection may be used to validate the result. The manual determined result my be fed to the system for improving the future validation process.

For example, consider with reference to FIG. 5, that the marker having marker ID #0001 520 (of the class “handwriting”) has already stored two appearances #0 and #1, and after step 608 it is determined that the new instance of the marker is “similar” to the previous appearances, then in step 609 the new appearance (#2) with its associated time tag will be added to the database, obviously with their corresponding feature instances, being informative of the fact that this is another appearance of the same handwriting marker #0001).

Reverting to FIG. 6, in case of rejection (611) appropriate notification is issued (612) e.g. through I/O module.

A more detailed sequence of operations of new and reference marker comparison, in accordance with certain embodiments of the recently disclosed subject matter, is discussed with reference to FIG. 7.

Thus, by one example, in step 700, for each new marker instance (7001), select candidate marker instances (referred to occasionally also as candidate reference marker instances or VIM) from the list of reference marker instances (7002). In some cases, a candidate marker instance is selected if it has the same marker class as the new marker (e.g. same color, or cross type screw). In another case, a reference marker is a match candidate if it is located on the same semantic component (as obtained e.g. in 104). In accordance with certain other embodiments, the candidate marker instance is selected if it belongs to the same class and is located in the same component. Note that the specified “class” and/or “location” are only examples, and, accordingly, other feature or features may be used instead of or in addition to the above for determining candidate markers.

Selecting candidate markers, by applying a narrowing criterion (exemplified in a non-limiting manner above) in order to reduce the number of candidate markers (out of the entire possible reference markers) allows to optimize computation complexity, since less comparisons will be made, and will also significantly lower the probability of a false match. By way of example, a simple scratch can appear on multiple locations on the vehicle. If the system attempts to compare a scratch on the chassis top left corner, to a scratch that is located on the exhaust, and by a matter of coincidence, the scratches have a similar visual appearance, this might result in a false match, and reduce the system's effectiveness. The latter scenario may be coped with by requiring that a candidate marker will be selected if it has the same class and resides in the same segment as that of the new marker. The invention is, of course, not bound by this example.

If, for example, an additional feature is taken into consideration e.g. the coordinates of the marker, then more fine-tuned candidate markers are obtained, which increases the likelihood of verifying (or rejecting) the vehicle identity, utilizing less computational resources and/or possibly less memory consumption. For instance, a reference scratch marker instance will be selected as a candidate marker if it has the same class as the new marker instance (i.e. a scratch by this example) and resides on the same component (say a plastic cover) in coordinates that are similar (say within a predefined tolerance) to the coordinates of the new marker on the plastic cover. These are, of course, only non-binding examples.

Moving on with FIG. 7, if a new marker instance has no match candidates (701), it is stored temporarily as a new marker candidate. If the vehicle identity is verified positively, this new marker will be regarded as a new modification to the vehicle that can later be used for identity verification (i.e. its pertinent data may be stored in the database as a marker instance of the so identified vehicle. Otherwise, the marker instance will be deleted from memory, or stored for another purpose.

If the marker has one or more match candidate markers, then a process of comparison, or marker verification, is invoked 701. In certain embodiments, for some of the markers, visual registration of the new reference marker instances may be required, due to changes in acquisition conditions (orientation, speed, light, angle, etc.), and, for some of these marker instances, visual registration may be done on the region bounding the semantic component the marker is found on (702). The specific algorithm used for the visual registration is generally known per se. There follows a non-limiting example of determining whether a matching criterion is met in order to validate the identity of the vehicle.

Thus, each of the visually registered new and reference candidate marker instance pairs is provided as an input to a compare system 703 which will determine the similarity score (704) of the pair, and, if exceeding a threshold, the new marker instance is validated. In other words, when validated, it may indicate (once the vehicle identity is verified-subject to a matching criterion) that the new marker instance is a new appearance of a reference marker instance. Such a comparison may be done in accordance with the marker class feature. By way of example, color marker histograms) can be compared by any distance metric such as Euclidian distance. For example, the specific histogram data (being an example of an instance of a feature) of the marker class color of currently scanned vehicle (or a segment of the currently scanned vehicle) may be compared to specific histogram data (being an example of an instance of a feature) of the marker class color of a stored vehicle and in the case that the comparison yields a similarity score that exceeds a given threshold, this is informative that the new marker instance is validated (similar histograms), namely if indeed the vehicle identity is validated (subject to the matching criterion discussed below) that the new marker instance is another appearance of the reference marker instance(s). By way of non-limiting example, the similarity score may be determined by calculating a distance function (e.g. Euclidean) between the histogram values, and if the distance is close enough, e.g. drops below a given threshold, this represents a similarity score that exceeds a given threshold which is informative of the fact that the marker class “color” of the currently scanned vehicle is the same as a marker instance of a reference (known) candidate vehicle whose data is already stored in the database, meaning that it is another appearance thereof. Note that the fact that the specified marker comparison has yielded a sufficient similarity score, does not necessarily mean that the matching criterion is met, i.e. that the candidate vehicle has been identified as the reference vehicle, because obviously different vehicles may share the same color.

Note that in order to decide whether the current marker instance is similar to a previously stored marker instance (i.e. it is another appearance thereof), the similarity score may apply to one feature (say requiring a similarity score that exceeds a threshold A for validating the new marker instance), or it may apply to more than one feature, (say requiring a first similarity score that exceeds a threshold A for a first feature and requiring a second similarity score that exceeds a threshold B for a similar feature—A and B are determined according to the feature).

Note that the invention not bound by the specified pair-wise comparison, i.e. a comparison between a new marker instance and a reference marker instance, but rather may involve more than two instances. For instance, a feature “vector” of a new marker instance may be compared to more than one reference vector features against a given threshold to determine to which (if any) it matches, or, by way of another non-limiting example that involves more than a pair-wise comparison, a distribution of few reference marker class instances may be calculated, and then the probability that the new marker class instance falls in the specified distribution is calculated and compared against a threshold, to determine whether it falls within the distribution (being informative of “similar”) or not (being informative of “not-similar”).

Reverting to another example of pair-wise comparison, a cross-type screw markers comparison can be done by subtracting the new (pertaining to currently scanned vehicle) and reference screws angle feature instance (pertaining to the already stored vehicle). Thus, for example, if the angle of the new marker instance relative to the reference line is 45 degrees, and the reference marker angle instance relative to the same reference line is 43 degrees, the difference is 2 degrees. A threshold (informative of the similarity score) can be then applied to determine whether the marker instance (i.e. the new screw) is verified (in case of exceeding the threshold-say, informative of 1.5 degrees). This means that in case that the vehicle's identity is verified, the new marker instance (screw) is a fresh appearance of the already stored marker instances (previous appearances of the same screw) screw, and otherwise are not.

While the example above referred to a single feature of the cross-type screw marker class, it will be evident from the description herein that in certain embodiments two or more marker features are compared before a decision on similarity can be made. For instance, the respective “reference line” and the “position on the component coordinates” features of the new Cross-type screw marker instance and the Cross-type screw marker instance are compared against corresponding thresholds in order to determine whether the new marker instance is similar to already stored marker feature.

Consider, by way of example, a handwriting marker class and exemplary defect classes, such as cracks, dents, etc. The comparison may be done in some cases using a visual similarity algorithm such as cross correlation, structural similarity or image difference etc., or a machine learning algorithm, such as DNN based algorithms.

With reference to the specific embodiment of DNN, the latter is pre-trained in such a way that for a given image patch, meaning, for example, an image patch that embraces the “handwriting” marker that is fed to the ML, the latter outputs a representation vector. During the training process, the network is provided with a plurality of input patches, for example if the vehicle was scanned n times (n appearances) respective n instances of the handwriting marker instances are “similar but not the same”, and the ML will output corresponding “similar” vectors representing the same handwriting marker instances, in such way that some of the patches represent different appearances of the same marker, and other patches represent appearances of different (i.e. not the same) markers.

By way of example, the loss function of the DNN network is configured for training in such a way that vector representations of different appearances of the same marker instance will be “closer” to each other than to vector representation of other markers.

The invention is, of course, not bound to utilizing ML in general, and DNN in particular, for determining the similarity between a new marker and a reference candidate marker.

In accordance with certain embodiments, during the inference phase, once the network is trained, the computation is done in the following way:

Given two marker appearances A, and B:

Provide an image portion containing the marker as input for the DNN, once for each marker. In response, the network outputs vector representations rep_A and rep_B. In case the markers' appearances represent difference appearances of the same marker instance, the resulting rep_A and rep_B (as outputted by the network) will be at “close distance” one from the other (namely similar—i.e. similarity score exceeded a threshold), whereas if rep_A and rep_B represent appearances of two different marker instances, they will be at a “far distance” one from the other (namely not similar—similarity score did not exceed a threshold). Now a post processing may be applied by computing the distance between the representations using the same distance used for training the network and obtaining a similarity score, e.g.: similarity_score=func(dist(rep_A,rep_B)), where func stands for a function. By one example Func(dist)=dist.

By way of example the dist can be cosine distance, Euclidean distance, etc.

The specified similarity score calculations are provided by way of example only. It is thus noted that the similarity score calculation techniques may vary depending upon the application, and different similarity score calculation techniques may apply to different classes and/or features, all depending upon the particular application. Note also that in accordance with certain embodiments, a similarity score may apply to a new representation and more than one previously stored representation (e.g. a new representation and the average of two or more previously stored representations), etc.

The output similarity score of 704 is provided to 705 (informative of verified marker instances—namely those marker instances whose scores exceeded the threshold). Now matching criterion is tested in 705 based on at least the number of validated marker instances and the stored marker instances, in order to determine whether vehicle identity is verified or not. For instance, in case that the validated marker instances out of the stored marker instances exceeds a given threshold (say 60%), the vehicle identity is verified (which means that every verified marker is a new appearance of a corresponding previously stored marker instance). Otherwise, if the matching criterion is not met, the vehicle's identity is rejected. The latter condition embraces the reverse test that may be applied in addition to or instead of the foregoing, i.e. checking the number of non-validated markers instances (i.e. which did not meet the similarity score test)

Consider the following non-limiting example:

In step 705 the calculated similarity scores are received and combined, providing a single decision about the vehicle identity being accepted or rejected.

While such A system can be implemented in multiple ways, one non-limiting example would be:
a. NV—Number of verified marker instances. A marker is considered verified if it has a matching candidate marker instance with a marker similarity score of, say, over 0.5
b. NO—number of original markers before the current verification attempt
c. TH—a threshold set to determine the system sensitivity (being an example of a matching criterion)
   If divide (NV,NO)>TH: accept identity (matching criterion is met)
   Else: Reject identity.

For instance, consider 20 different marker instances in the database (as exemplified with reference to FIG. 5)—informative of 20 scratches that were revealed in previous scans and which characterizes a vehicle (having a license plate XYZ), thus by this example NO=20. Further consider that from the newly obtained markers, only 5 were verified, i.e. their respective similarity scores when compared to candidate markers exceeded 0.5, i.e. NV=5 (verified markers). If, by this example, the threshold for accepting (verifying) a vehicle is, say 60%, and considering that in the latter example the decision score is 25% (5/20), then the decision in this example is reject.

The invention is of course not bound by the number of features that are processed and or the respective threshold(s) that are used in order to determine that a new marker instance is a verified appearance of an already stored marker instance (e.g. that it is the same scratch), and obviously not by the specified example of determining vehicle validation, and, accordingly, a different and/or more complex condition (than the specified divide (NV,NO)>TH) may be used (based on at least validated marker instances).

In accordance with certain embodiments, in case the identity is accepted, all new marker instances that were matched to reference marker instances are registered as a new appearance in database (5b). Markers that were not matched, are saved as new marker instance (possibly indicating new marker instances—say new scratches) that were not present on previous scans. The newly stored marker instances can further be used for identity verification of future scans of the vehicle and improve accuracy of validation, as they represent a more fresh appearance of the vehicle. In some cases, the result of identity acceptance is displayed on the GUI 126.

It is to be noted that in some cases part of the identity accept or reject mechanism in 705 takes into account also reference markers, forcing a condition of some reference markers to be verified as part of the identity verification process. For example, if scan N+1 has 2 markers detected, but the previous scan N had 20 markers, the identity might be rejected, even if the 2 new markers have a match, since a minimal number of past matches was not met.

It is appreciated that the examples and embodiments illustrated with reference to the determining and logging (storing) and fingerprint of a vehicle for various purposes, including verifying identity thereof in the present description, are by no means inclusive of all possible alternatives, but are intended to illustrate non-limiting examples only.

Note that while for simplicity of explanation, the description referred predominantly to visual aspects of appearance and markers, such as a vehicle image scan, visual segments and components, visual markers, and classes (e.g. scratches, dents etc.), and pertinent features, the invention likewise applies to non-visual markers such as sound markers in lieu of or in addition to the visual ones, mutatis mutandis, for instance, a specific set of frequencies that the engine of the vehicle produce that is unique to the vehicle. As specified above, other non-visual markers, such as electromagnetic marker classes (say, for detecting certain defects concealed under non-metal surface of the vehicle) using Radar or Lidar sensor, and/or IR marker classes may be utilized (say, for representing the heat signature of a certain component) using an IR sensor, and/or audio marker classes using e.g. audio (say, a microphone). The specified sensors and/or marker classes and/or what they represent in connection with the vehicle are non-limiting examples only.

The system and method of the various embodiments of the invention may be used for unequivocally verifying vehicles. For example, in case a vehicle is authorized to enter a sensitive site, say an electrical company facility, there is a need to verify that only authorized vehicles will be permitted to enter. To date, the car model, color, and the license plate have been used as means to validate entry of the vehicle. However, unauthorized persons may easily mount an authorized plate number to an unauthorized car (say, of a similar model and color), and unduly enter the sensitive facility, for hostile purposes. In contrast, utilizing the technique in accordance with various embodiments of the invention may cope with such risky scenarios, as the unauthorized car's identity will be rejected, as it will not have sufficient “similar” marker instances to those of the authorized vehicle whose marker instances are stored in the database.

By way of another example, considering an automatic car service utility (say, a car washing service), where a car's identity should be validated before service is provided. By using the teaching of various embodiments of the invention, a forged usage may be prevented (e.g. by mounting a license plate of an authorized car on an unauthorized car), thereby unduly receiving service for the unauthorized car, which obviously may lead to significant financial implications. The usage of the teaching of the various embodiments of the invention, that lead to unequivocal validation of the identity of the car under service, will cope with the specified problem and the pertinent financial losses.

The invention is not bound by these examples, and any usage that benefits from an unequivocal validation of a vehicle's identity may be applicable, including those with financial implications.

It is to be noted that certain stages/steps illustrated in the figures and/or described with reference thereto may be executed differently, such as, e.g., executed in opposite order, and/or executed simultaneously or sequentially. The present disclosure is not limited by the specific order or sequence as illustrated or described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer readable memory or storage medium tangibly embodying a program of instructions executable by the computer for executing the method of the invention.

The non-transitory computer readable storage medium causing a processor to carry out aspects of the present invention can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Those skilled in the art will readily appreciate that various modifications and changes can be applied to the embodiments of the invention as hereinbefore described without departing from its scope, defined in and by the appended claims.

1. A method for determining a fingerprint of a vehicle, comprising, by a processor and memory circuitry (PMC):
a) receiving a vehicle identifier;
b) receiving, from at least one sensor, at least one vehicle appearance each including at least one image data indicative of at least partial vehicle scan; said appearance is associated with a unique appearance time tag;
c) segmenting said image data into segment data that includes segments each being informative of a respective at least one-sub-component of said vehicle;
d) determining a plurality of marker instances from said image scan or segment data, wherein each marker instance is associated with a marker class and at least one marker feature;
e) storing in the storage data indicative of the vehicle's fingerprint including said vehicle identifier and at least its corresponding (i) vehicle appearance and associated appearance time tag, (ii) the so determined marker instances,
thereby facilitating verification of the fingerprint of said vehicle in future vehicle scan(s).

2. The method according to claim 1 further comprising: determining at least one marker feature instance for each one of said marker instances and for at least one of said the marker classes of the marker instance, determining at least one marker feature instance that is location dependent; and, for each marker instance, storing the so determined marker feature instances including said component dependent marker features.

3. The method according to claim 1, including with respect to said vehicle, repeating said (b) to (e) for at least one more vehicle appearance having a corresponding unique time tag, and for at least one other vehicle.

4. The method according to claim 1, wherein said marker class is selected from the group that includes: scratches, dents, handwriting, color, rust mark, cross-type screws, and printed text.

5. The method according to claim 1, wherein at least one of said sensors is an IR sensor and wherein at least one of said vehicle scans falls in the IR wavelength.

6. The method according to claim 1, wherein at least one of said sensors is an audio sensor and further comprising obtaining at least one audio scan of the vehicle and determining at least one audio marker class from said scan informative of sound of at least one module associated with said vehicle.

7. The method according to claim 1, wherein at least one of said sensors is an electromagnetic sensor and further comprising obtaining at least one electromagnetic scan of the vehicle and determining at least one electromagnetic marker class from said scan informative of a mark concealed underneath a non-metal surface of the vehicle.

8. A method for verifying a fingerprint of a vehicle, comprising by a processor and associated memory storage:
a) receiving a vehicle identifier;
b) receiving from at least one sensor at least one new vehicle appearance, each including at least one image data indicative of at least a partial vehicle scan; said appearance is associated with a unique appearance time tag;
c) segmenting said image data into segment data that includes segments each being informative of a respective at least one-sub-component of said vehicle;
d) determining a plurality of new marker instances from said image scan or segment data, wherein each new marker instance is associated with a marker class and at least one marker feature;
e) extracting from said storage previously stored at least one vehicle appearance that is associated with said vehicle identifier and at least one of its corresponding marker instances; and
f) comparing at least one new marker instance of the new appearance with a corresponding marker instance of at least one previously stored appearance of the same vehicle identifier, and validating said vehicle fingerprint if a matching criterion is met.

9. The method according to claim 8, wherein said (d) further includes determining at least one new marker feature instance for each one of said new marker instances and for at least one of the marker classes of said new instances, determining at least one marker feature instance that is location dependent, and wherein said extracting step includes: for each marker instance, extracting determined marker features including location dependent marker features, and wherein said comparing includes comparing each new marker instance with at least one marker instance of at least one previously stored appearance of said vehicle for determining respective similarity scores, and in case at least one of said similarity scored exceeds a threshold validating said new marker instance, determining if said matching criterion is met based on at least the validated marker instances and the corresponding stored marker instances.

10. The method according to claim 9, further comprising for at least one validated marker instance of the newly acquired appearance,
determining, utilizing a narrowing criterion, at least one candidate reference marker instance out of the larger number of stored reference marker instances of at least one vehicle appearance, and determining whether said matching criterion is met based on at least the validated marker instances and the corresponding stored candidate reference marker instances.

11. The method according to claim 9, wherein said matching criterion is met if the number of validated marker instances out of the corresponding stored marker instances exceeds a given threshold.

12. The method according to claim 8, wherein at least some of said features are component dependent, and wherein said comparison is segment dependent thereby reducing the false alarms and computational complexity of said comparison.

13. The method according to claim 8, wherein in case that a matching criterion is met with respect to the validated vehicle, the new marker instances of the validated vehicle that did not meet the similarity score are stored together with their associated feature instances for improving future vehicle verification.

14. The method according to claim 8, wherein said marker class is selected from the group that includes: scratches, dents, handwriting, color, rust mark, cross-type screws, and printed text.

15. The method according to the claim 8, wherein at least one of said sensors is an IR sensor and wherein at least one of said vehicle scans falls in the IR wavelength.

16. The method according to claim 8, wherein at least one of said sensors is an audio sensor and further comprising obtaining at least one audio scan of the vehicle and determining at least one audio marker class from said scan informative of sound of at least one module associated with said vehicle, and wherein said extracting and comparing apply also to said audio marker classes.

17. The method according to claim 8, wherein at least one of said sensors is an electromagnetic sensor and further comprising obtaining at least one electromagnetic scan of the vehicle and determining at least one electromagnetic marker class from said scan informative of a mark concealed underneath a non-metal surface of the vehicle, and wherein said extracting and comparing apply also to said electromagnetic marker classes.

18. A computerized system for determining a fingerprint of a vehicle, the system comprising a processor and memory circuitry (PMC) configured to perform:
receive a vehicle identifier;
receive, from at least one sensor, at least one vehicle appearance each including at least one image data indicative of at least partial vehicle scan; said appearance is associated with a unique appearance time tag;
segment said image data into segment data that includes segments, each being informative of a respective at least one-sub-component of said vehicle;
determine a plurality of marker instances from said image scan or segment data, wherein each marker instance is associated with a marker class and at least one marker feature;
store, in the storage, data indicative of the vehicle's fingerprint, including said vehicle identifier and at least its corresponding (i) vehicle appearance and associated appearance time tag, (ii) the so determined marker instances,
thereby facilitating verification of the fingerprint of said vehicle in future vehicle scan(s).

19. A computerized system for verifying a fingerprint of a vehicle, the system comprising a processor and memory circuitry (PMC) configured to perform:
receive a vehicle identifier;
receive from at least one sensor at least one new vehicle appearance each including at least one image data indicative of at least partial vehicle scan; said appearance is associated with a unique appearance time tag;
segment said image data into segment data that includes segments each being informative of a respective at least one-sub-component of said vehicle;
determine a plurality of new marker instances from said image scan or segment data, wherein each new marker instance is associated with a marker class and at least one marker feature;
extract from said storage previously stored at least one vehicle appearance that is associated with said vehicle identifier and at least one of its corresponding marker instances; and
compare at least one new marker instance of the new appearance with the corresponding marker instance of at least one previously stored appearance of the same vehicle identifier, and validating said vehicle fingerprint if a matching criterion is met.

20. A non-transitory computer readable medium comprising instructions that, when executed by a computer, cause the computer to perform method steps of
a) receiving a vehicle identifier;
b) receiving, from at least one sensor, at least one vehicle appearance each including at least one image data indicative of at least partial vehicle scan; said appearance is associated with a unique appearance time tag;
c) segmenting said image data into segment data that includes segments each being informative of a respective at least one-sub-component of said vehicle;
d) determining a plurality of marker instances from said image scan or segment data, wherein each marker instance is associated with a marker class and at least one marker feature;
e) storing in the storage data indicative of the vehicle's fingerprint including said vehicle identifier and at least its corresponding (i) vehicle appearance and associated appearance time tag, (ii) the so determined marker instances,
thereby facilitating verification of the fingerprint of said vehicle in future vehicle scan(s).

21. A non-transitory computer readable medium comprising instructions that, when executed by a computer, cause the computer to perform method steps of
a) receiving a vehicle identifier;
b) receiving from at least one sensor at least one new vehicle appearance, each including at least one image data indicative of at least a partial vehicle scan; said appearance is associated with a unique appearance time tag;
d) segmenting said image data into segment data that includes segments each being informative of a respective at least one-sub-component of said vehicle;
g) determining a plurality of new marker instances from said image scan or segment data, wherein each new marker instance is associated with a marker class and at least one marker feature;
h) extracting from said storage previously stored at least one vehicle appearance that is associated with said vehicle identifier and at least one of its corresponding marker instances; and
i) comparing at least one new marker instance of the new appearance with a corresponding marker instance of at least one previously stored appearance of the same vehicle identifier, and validating said vehicle fingerprint if a matching criterion is met.
